(19) United States
(12) Patent Application Publication
(10) Pub. No.: US 2019/0090085 A1
(43) Pub. Date: Mar. 21, 2019

(54) CONFIGURATION OF A COMPUTING DEVICE WITH A GEOFENCE FOR ACCESSING AN OBJECT

(71) Applicant: Microsoft Technology Licensing, LLC, Redmond, WA (US)

(72) Inventors: Clark MASTERSON, Sammamish, WA (US); Joao Celestino LEITE PINHEIRO DE PAIVA, Issaquah, WA (US); Silvana P. MONCAYO, Seattle, WA (US); Shai GUDAY, Redmond, WA (US)

(21) Appl. No.: 15/707,917

(22) Filed: Sep. 18, 2017

(51) Int. Cl. H04W 4/02; H04M 1/725

(52) U.S. Cl. CPC H04W 4/021; H04M 1/72572; H04W 4/023

(57) ABSTRACT

In some embodiments, a first computing system receives, at an application running on a platform of the first computer system, a communication for an object from a second computer system. The application determines that a geofence is associated with the object. The geofence is set by the second computer system and the application restricts access to the object until a requirement associated with the geofence is met. The application configures a location service of the platform to monitor a location of the first computer system using the information for the geofence. A notification is received from the location service when the location of the first computer system meets a requirement of the geofence. Then, the application performs an action for the object when the first computer system meets the requirement of the geofence.

### BACKGROUND

A first user can send messages, such as short message service (SMS) messages, and other content or communications, to a second user through a variety of applications. Users may use applications running on a computing device to send messages, such as an SMS application. The application may be configured to deliver the messages as soon as possible. Since the application attempts to deliver the message as soon as possible, the application may not provide any delivery options other than allowing a user to send the message. For example, the first user uses an application to compose a message to deliver to a second user. The application allows the first user to enter text for the message and identify the second user. Then, the first user can send the message. Once the first user sends the message, a service then delivers the messages to the second user as soon as possible after the first user sends the message. For example, whenever the second user is able to receive messages, the service will forward the message to the second user.

### SUMMARY

In some embodiments, a first computing system receives, at an application running on a platform of the first computer system, a communication for an object from a second computer system. The application determines that a geofence is associated with the object. The geofence is set by the second computer system and the application restricts access to the object until a requirement associated with the geofence is met. The application configures a location service of the platform to monitor a location of the first computer system using the information for the geofence. A notification is received from the location service when the location of the first computer system meets a requirement of the geofence. Then, the application performs an action for the object that is associated with the geofence when the first computer system meets the requirement of the geofence.

In some embodiments, a method includes: receiving, at an application running on a platform of a first computer system, a communication for an object from a second computer system; determining, by the application, that a geofence is associated with the object, wherein the geofence is set by the second computer system and the application restricts access to the object until a requirement associated with the geofence is met; configuring, by the application, a location service of the platform to monitor a location of the first computer system using the information for the geofence; receiving, by the application, a notification from the location service when the location of the first computer system meets a requirement of the geofence; and performing, by the application, an action for the object when the first computer system meets the requirement of the geofence.

In some embodiments, a computer readable storage medium has stored thereon program code executable by a computer system. The program code causes the computer system to: receive, at an application running on a platform of the first computer system, a communication for an object from a second computer system; determine, by the application, that a geofence is associated with the object, wherein the geofence is set by the second computer system and the application restricts access to the object until a requirement associated with the geofence is met; configure, by the application, a location service of the platform to monitor a location of the first computer system using the information for the geofence; receive, by the application, a notification from the location service when the location of the first computer system meets a requirement of the geofence; and perform, by the application, an action for the object when the first computer system meets the requirement of the geofence.

### BRIEF DESCRIPTION OF THE DRAWINGS

FIG. 1 depicts a simplified system for associating a geofence with an object according to some embodiments.

FIG. 2A depicts a more detailed example of a geofence service according to some embodiments.

FIG. 2B depicts an example of information that geofence service stores in storage according to some embodiments.

FIG. 3 depicts a more detailed example of a second computing device according to some embodiments.

FIG. 4 depicts a simplified flowchart of a method for providing geo-triggered objects according to some embodiments.

FIG. 5 depicts a simplified flowchart of a method for processing the object and geofence at the geofence service according to some embodiments.

FIG. 6 depicts a simplified flowchart of a method for using the geofence at the second computing device according to some embodiments.

FIG. 7 depicts a simplified flowchart of a method for providing geo-triggered notifications according to some embodiments.

FIG. 8A depicts a simplified flowchart of a method for providing geo-locked content according to some embodiments.

FIG. 8B depicts a simplified flowchart of a method for providing geo-locked content at geofence service according to some embodiments.

FIG. 9 depicts a simplified block diagram of an example computer system according to certain embodiments.

### DETAILED DESCRIPTION

An application allows users to associate a geofence with an object. A geofence may be a virtual boundary that is associated with a geographic area. The application can then configure a computing device of another user to provide access to the object based on the geofence. For example, a first user may set a geofence for an object on a first computing device. Then, the first computing device can associate the geofence with the object in a package, which is sent to a second user. A geofence service receives the package and then forwards the geofence to the second user. A second computing device for the second user then configures a location service of the second computing device with the geofence. For example, the location service may store a boundary for the geofence and test when the second computing device meets requirements of the geofence, such as moving within the boundary. When the second computing device meets the requirements of the geofence, the second computing device may then perform an action with respect to the object associated with the geofence, such as displaying the object (if it has already been downloaded) or sending a request for the object to the geofence service and subsequently receiving and displaying the object. For example, the second computing device may display a message that the first user wanted to share with the second user at a location.

The first user can configure different scenarios to be performed with an object that is associated with a geofence. For example, one scenario may include geo-triggered messages where the second computing device provides access to objects when the second computing device meets the requirements of the geofence. Also, another scenario may include geo-triggered activity notifications where a first user receives a notification that the second user has either entered or left a location associated with the geofence. Further, another scenario may include geo-locked objects that associate objects with a location and allow users to access the object when they are within (or not within) the geofence associated with the location.

For example, in the scenario of geo-triggered messages, the first user can select the object the first user wants to share, specify the second user (and any other users), and where the object should be consumed by the second user. The first user may use a messaging application to input a message to send to a second user. However, the first user wants the second user to only be able to access the message when the second user gets to a location, such as the location where the second user works. To set the geofence, the first user selects the place of the second user's work on a map, inputs the address, or specifies the geofence in another way. When the second user gets to work, the second user can unlock and receive the message.

Accordingly, some embodiments allow users to set geofences on other user's computing devices. The second computing device uses the package to configure location services of the second computing device. Then, a location of the second computing device is used to determine when to deliver an object. The conditional delivery of the object provides many scenarios that improve an object delivery system.

Overview

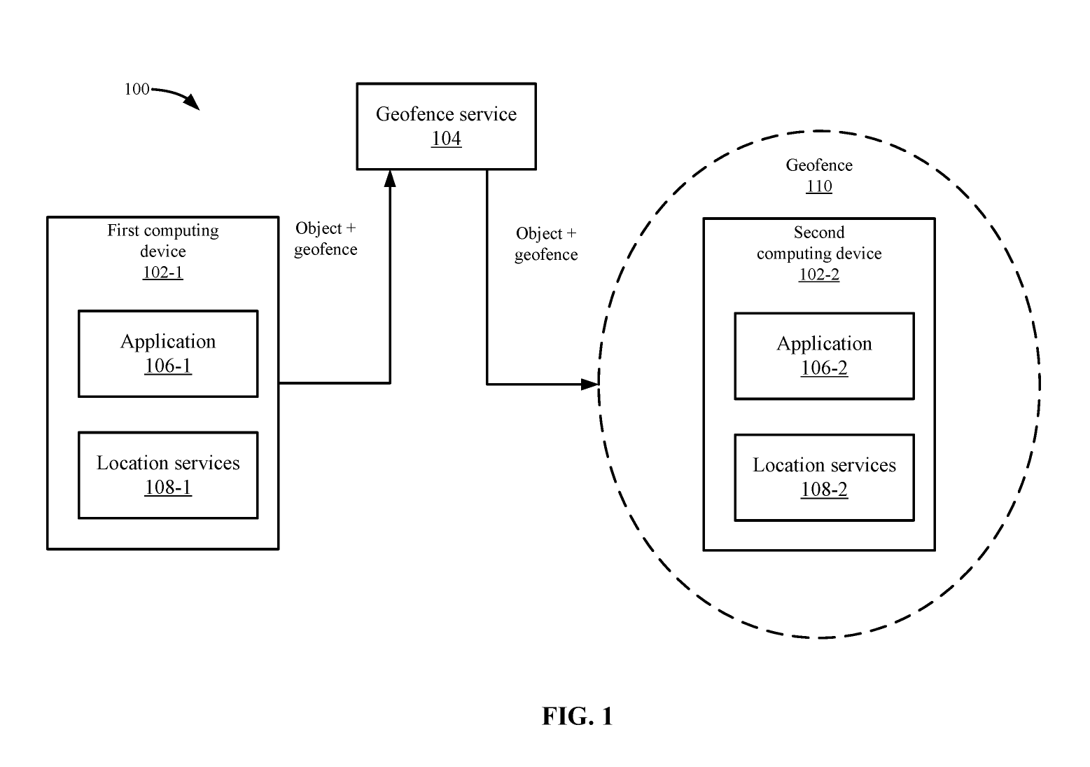

FIG. 1 depicts a simplified system 100 for associating a geofence with an object according to some embodiments. System 100 includes a first computing device 102-1, a second computing device 102-2, and a geofence service 104. Although only two computing devices are shown, it will be understood that geofence service 104 may be servicing multiple computing devices. Also, geofence service 104 may be a separate service from computing devices 102 or may be integrated into one of the computing devices.

Applications 106-1 and 106-2 may be any application that is running on computing devices 102-1 and 102-2 respectively that allow the association of a geofence 110 with an object. For example, application 106-1 and application 106-2 may be the same application, such as a messaging application. In other examples, application 106-1 and application 106-2 may be different applications, such as application 106-1 may be a messaging application and application 106-2 may be a social media application where both applications can communicate with each other. In either case, applications 106-1 and 106-2 can provide the functions described herein with respect to the object and geofence 110.

Location services 108-1 and 108-2 may be used to determine a location of first computing device 102-1 and second computing device 102-2, respectively. In the example described, location services 108-1 and 108-2 may use sensors that can detect a location of first computing device 102-1 and second computing device 102-2, respectively. As will be described below, location services 108-1 and 108-2 may be part of a platform (e.g., the operating system and/or hardware) of first computing device 102-1 and second computing device 102-2, respectively.

In some examples, first computing device 102-1 uses application 106-1 to associate a geofence 110 with an object. Application 106-1 may include an option to add geofence 110 to an object. For example, application 106-1 may include a selectable option to add a geofence to a message. When selected, the first user can define geofence 110. For example, the first user may specify boundaries in different ways, such as by latitude and longitude coordinates with a radius, by defining other shapes around coordinates, by selecting an area on a map, by a moving boundary along a vector, by a name of a location, etc.

The object may be content, such as a message, an e-mail, or a notification. In some examples, the object may not always be displayed to a user. For example, the object may cause an action to be performed, such as the object causes second computing device 102-2 to enter into an operating mode, such as locked state, or send a notification to the first user.

When a first user wants to associate a geofence 110 with an object, application 106-1 receives an input from the first user specifying the object and geofence 110. Application 106-1 may associate geofence 110 with the object in a package. The package may be an entity that can be forwarded to other components of system 100, such as geofence service 104 and second computing device 102-2.

In some examples, application 106-1 may use location services 108-1 to generate geofence 110 for the object. For example, location services 108-1 may translate a user selection on a map to latitude/longitude coordinates and a radius. In other examples, the user may input the latitude/longitude coordinates and a radius, or input a boundary on a map to specify geofence 110. Geofence 110 may be associated with a physical boundary in the physical world (e.g., coordinates translatable to a position on the Earth) as described above. However, geofence 110 may also be associated with a boundary in a virtual world. For example, geofence 110 may be found in a video game or virtual reality world.

Geofence 110 may be associated with one or more requirements that need to be met. That is, access to the object is restricted until the requirements are met, such as the second user needs to enter into the boundary formed by geofence 110, leave the boundary, stay in the boundary for a certain amount of time, etc. The requirements may also include timing, such as the user may need to enter the boundary during a certain time range, at a certain time, or for a certain amount of time. In the package, geofence 110 may be stored as metadata to a payload that includes content for the object. The requirements may be enforced in the physical world or virtual world. Also, the boundaries in the virtual world may map to the physical world. For example, a requirement that is met in the virtual world may correspond to meeting a requirement in the physical world. Also, the opposite may be true where a requirement that is met in the physical world may correspond to meeting a requirement in the virtual world.

Application 106-1 then sends package including the object and geofence 110 to a second computing device 102-2 that is operated by a second user. For example, application 106-2 sends the package to a user identifier for the second user, a machine identifier for second computing device 102-2, or using other methods to identify the second user. In some embodiments, geofence service 104 may be used to forward geofence 110 to second computing device 102-2 when second computing device 102-2 is available to receive geofence 110. For example, application 106-1 sends the message addressed to the second user to geofence service 104 or geofence service 104 may intercept the message. As will be discussed in further detail below, geofence service 104 may initially send the object to second computing device 102-2 or may wait to send the object to second computing device 102-2. For example, geofence service 104 may wait until second computing device 102-2 meets the requirements of geofence 110, such as going within the boundary of geofence 110 or leaving the boundary of geofence 110 to send the object.

When available, second computing device 102-2 receives geofence 110 at application 106-2 and recognizes that a geofence has be associated with the object. For example, if the object is sent with geofence 110, then information in the package may indicate a geofence is set and application 106-2 can determine that the second user should not be able to access the object until the requirements of the geofence are met. In other examples, second computing device 102-2 receives geofence 110 and a reference to the object. Again, second computing device 102-2 can determine that the second user should not be able access to the object until the requirements of the geofence are met. When a geofence 110 is not set, then application 106-2 may provide the second user access to the object right away, such as by displaying a message without enforcing any requirements of a geofence.

When geofence 110 is associated with an object, second computing device 102-2 sets geofence 110 with location services 108-2. Once geofence 110 is set, location services 108-2 may monitor the location of second computing device 102-2 to determine whether or not second computing device 102-2 meets the requirements of geofence 110. When the requirements are met, such as when second computing device 102-2 moves within geofence 110, location services 108-2 may notify application 106-2. Then, application 106-2 may perform an action associated with the object. For example, the action may include providing access to the object to the second user, such as displaying a message to the second user.

Some options for the use of the geofence service include that communications between first computing device 102-1 and second computing device 102-2 are encrypted to prevent any malicious accessing of the data, such as the location data or object. Also, users may need to consent to access by other users before they can receive geo-triggered objects. For example, the geo-triggered objects require access to the computing device's location and thus the second user may need to consent to receiving geo-triggered objects.

Geofence Service

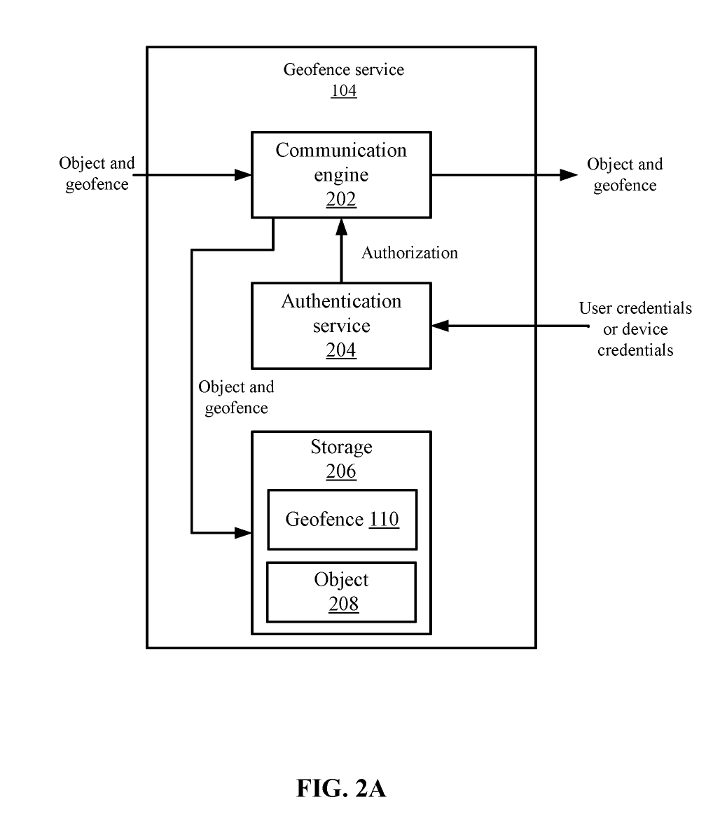

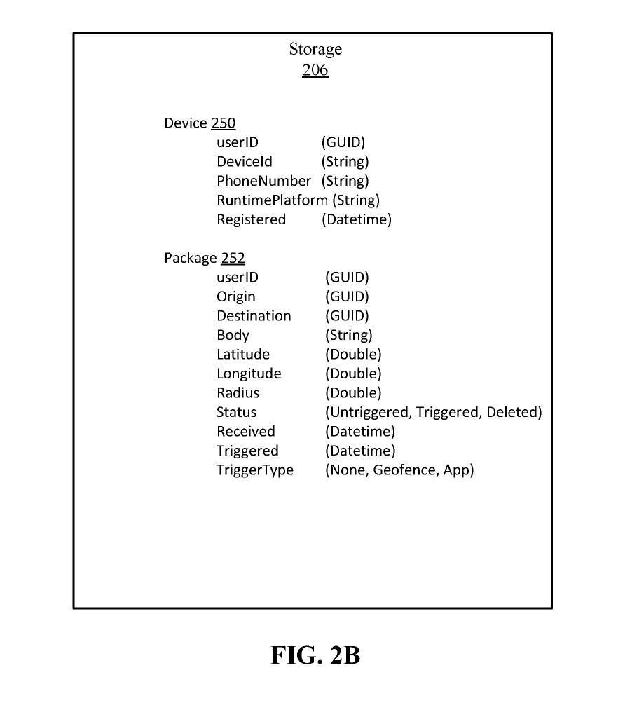

FIG. 2A depicts a more detailed example of geofence service 104 according to some embodiments. Geofence service 104 includes a communication engine 202, authentication service 204, and storage 206.

Communication engine 202 may provide a store and forward service. For example, communication engine 202 may store geofence 110 and the object at 208 in storage 206. Then, when second computing device 102-2 is available to receive geofence 110, communication engine 202 sends geofence 110 to second computing device 102-2. Also, depending on the embodiment, communication engine 202 may send the object to second computing device 102-2 with geofence 110 or may wait until the requirements of geofence 110 are met to send the object.

Authentication service 204 may also authorize whether or not second computing device 102-2 is authorized to access the object. For example, the first user may set permissions on the object, such as only the second user can access the object. Thus, if multiple users are using second computing device 102-2, the second user may need to enter user credentials to authenticate himself or herself to authentication service 204. The user credentials may include any unique user information, such as a user identifier and password. In other examples, any user of second computing device 102-2 may be able to access the object and authentication service 204 may use machine credentials to authorize the access. The machine credentials may include any unique identifier for second computing device 102-2. Upon authentication, communication engine 202 may receive an authorization from authentication service 204 and then send geofence 110 and the object to second computing device 102-2. In other embodiments, communication engine 202 may send geofence 110 first and then upon authorization, send the object to second computing device 102-2. Also, geofence service 104 may not need to authorize the second user to be able to send the object to the second user.

Geofence service 104 may store information for the object and geofence 110 in storage 206 in different formats. FIG. 2B depicts an example of information that geofence service 104 stores in storage 206 according to some embodiments. For example, geofence service 104 may store a device entry 250 and a package entry 252. Device entry 250 may describe the second user, such as a user ID (userID) for the second user, a device ID (deviceID) that identifies second computing device 102-2, and a phone number (PhoneNumber) for the user. A runtime platform (RuntimePlatform) may be the platform 202 associated with second computing device 102-2. A registered date may be when the second user registered for the service and possibly gave permissions needed for the service.

For the package entry 252, a user ID for the second user is stored that can access the object. An origin may be an address for the first user and a destination may be an address for the second user. The body may be the information for the object, such as the content of the object. The latitude, longitude, and radius may be coordinates for the latitude, longitude, and the radius that define the boundary of geofence 110.

The status entry is whether or not the geofence has been un-triggered, triggered, or deleted. The received entry is when the package was received, and also the triggered entry is when the geofence was triggered. The trigger type (TriggerType) is whether or not the geofence was triggered via the location or overridden by the app.

Geofence service 104 may determine some of the above information based on the package received from application 106-1. Also, geofence service 104 may enter information in device entry 250 or package entry 252 as needed, such as when an object is accessed based on the second user meeting the requirements of geofence 110.

Second Computing Device

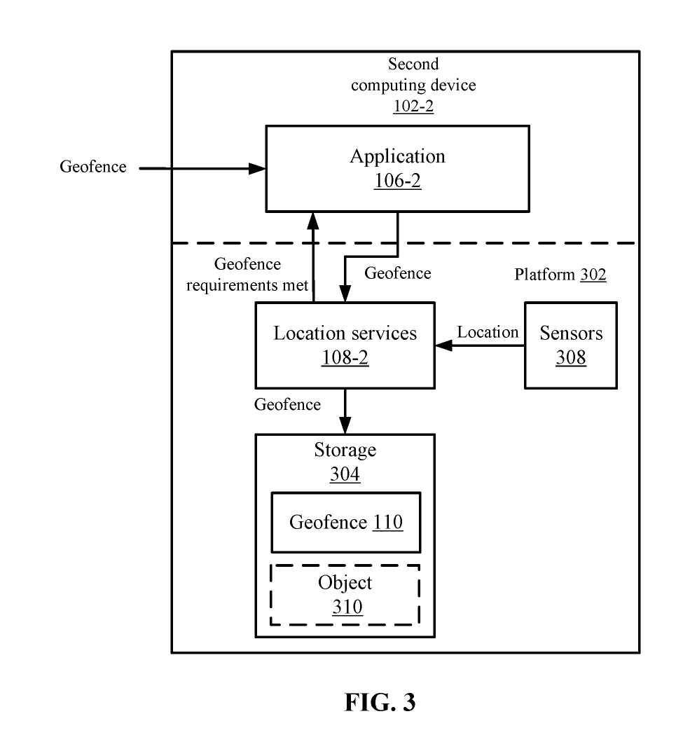

FIG. 3 depicts a more detailed example of second computing device 102-2 according to some embodiments. It will be understood that first computing device 102-1 may perform similar functions as described and also include a similar architecture.

Application 106-2 may be running at the application level in second computing device 102-2. For example, application 106-2 may be running on a platform 302 of second computing device 102-2. Platform 302 may be hardware and/or an operating system or other software that may be installed on the hardware of second computing device 102-2. In some embodiments, platform 302 natively includes location services 108-2 in which various applications running on platform 302 can access location services 108-2. For example, location services 108-2 may provide its services to application 106-2, but also to other applications running on second computing device 102-2.

Location services 108-2 receive location information from sensors 308. Sensors 308 may include different sensors of second computing device 102-2, such as global positioning system (GPS) sensors, cellular signal sensors, WiFi, Ethernet, etc. Sensors 308 may sense location information using various methods, such as a GPS sensor may provide GPS coordinates of second computing device 102-2 to location services 108-2, cellular signal sensors use triangulation to determine a location, etc.

Application 106-2 receives geofence 110 from geofence service 104 and provides geofence 110 to location services 108-2. Application 106-2 may use application programming interfaces (APIs) to access location services 108-2. For example, platform 202 may have geofencing APIs that allow applications to communicate with location services 108-2 to set geofences. Application 106-2 uses the APIs to provide geofence 110 and any requirements of geofence 110 to locations services 108-2.

Once receiving geofence 110, location services 108-2 can then store geofence 110 in storage 304 with any of the requirements for geofence 110. For example, location services 108-2 may store the boundary defined by geofence 110. Location services 108-2 may also set other information, such as any requirements that location services 108-2 monitors with respect to geofence 110. For example, location services 108-2 may monitor a location received from sensors 308 and compare the location to the requirements of geofence 110. When the location meets the requirements of geofence 110, location services 108-2 may notify application 106-2.

One advantage of using location services 108-2 to monitor the location and apply the requirements of geofence 110 to the location is that location services 108-2 may be running in the background on platform 302. Running in the background allows location services 108-2 to be active without being open on second computing device 102-2. It is possible that application 106-2 may not always be running on second computing device 102-2, such as a user may close application 106-2. If application 106-2 was responsible for monitoring the location of geofence 110, then it is possible that application 106-2 may not detect when second computing device 102-2 meets the requirements of geofence 110 because it is closed. However, using location services 108-2 in platform 302 allows second computing device 102-2 to monitor the location even when application 106-2 might not be running. Further, using location services 108-2 may use less computing resources because application 106-2 does not need to communicate with location services 108-2 to determine the location continuously. Rather, location services 108-2 notifies application 106-2 when the requirements are met without requiring application 106-2 to query location services 108-2 to determine if the requirements are met. However, although using location services 108-2 is described, it will be understood that application 106-2 may monitor the location of second computing device 102-2 either with its own location services or by communicating with location services 108-2 and/or sensors 308.

When the geofence requirements are met and location services 108-2 sends a notification to application 106-2, application 106-2 may then perform different actions. For example, if the object has already been received at second computing device 102-2, then an object may have been stored in storage 304 at 310. In this case, application 106-2 retrieves the object from storage 304 and may provide the second user access to the object. In other examples, as will be described in more detail below, application 106-2 may send a request to geofence service 104 for the object and then subsequently receive the object from geofence service 104.

Accordingly, using applications 106-1 and 106-2, the first user can remotely set geofences on other computing devices 102-2. The configuration changes a state of computing device 102-2 to monitor whether the requirements of geofence 110 are met. Also, the applications functionality is enhanced by allowing location to be enforced for communicating objects between users. Also, the use of location services 108-2 of platform 302 allows the geofencing service to be run in the background and not depend on application 106-2 to be currently running.

The different types of scenarios can be performed will be described in more detail now. Some examples include geo-triggered objects, geo-triggered activity notifications, and geo-locked objects, but other scenarios may be appreciated.

Geo-Triggered Objects

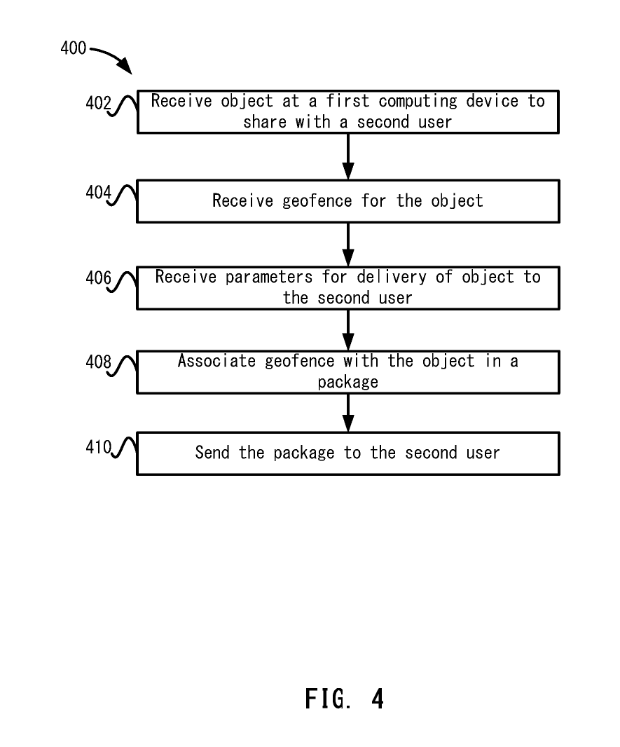

The following will describe a first scenario in which objects can be geo-triggered. FIG. 4 depicts a simplified flowchart 400 of a method for providing geo-triggered objects according to some embodiments. In the scenario, a first user of first computing device 102-1 may have an object, such as a message, content, or other information, that the first user wants to share with a second user (or multiple users) at a location. To perform the process on first computing device 102-1, at 402, application 106-1 receives an object at first computing device 102-1 to share with a second user. The first user may identify the second user with a user ID for the second user or a machine ID for a second computing device 102-2 associated with the second user.

At 404, application 106-1 receives a geofence 110 for the object. The first user may specify geofence 110 in different ways, such as the first user may input coordinates for geofence 110 and a boundary, such as latitude and longitude coordinates with a radius, select a location on a map on application 106-2, input a name of a location, input an address, etc.

At 406, application 106-1 receives parameters for the delivery of the object to the second user. For example, the first user may want to set requirements as to how the second user can access the object. Some requirements may be that the second user needs to be within the boundary of geofence 110 or that the second user needs to leave the boundary of geofence 110, stay within the boundary of geofence 110 for a certain amount of time, etc. In some examples, a default requirement may be that the second user has to enter the boundary of geofence 110 to receive the object.

At 408, application 106-1 associates geofence 110 with the object in a package. For example, parameters for geofence 110 may be associated with a payload that includes the message content along with other information described in FIG. 2B. Using the package, the object and geofence 110 are tied together in an entity that can be forwarded. For example, when second computing device 102-2 receives the package, second computing device 102-2 can forward the package to another device and/or a third user. The third user can then access the object when the requirements of geofence 110 are met. Also, geofence service 104 may forward the package to multiple users.

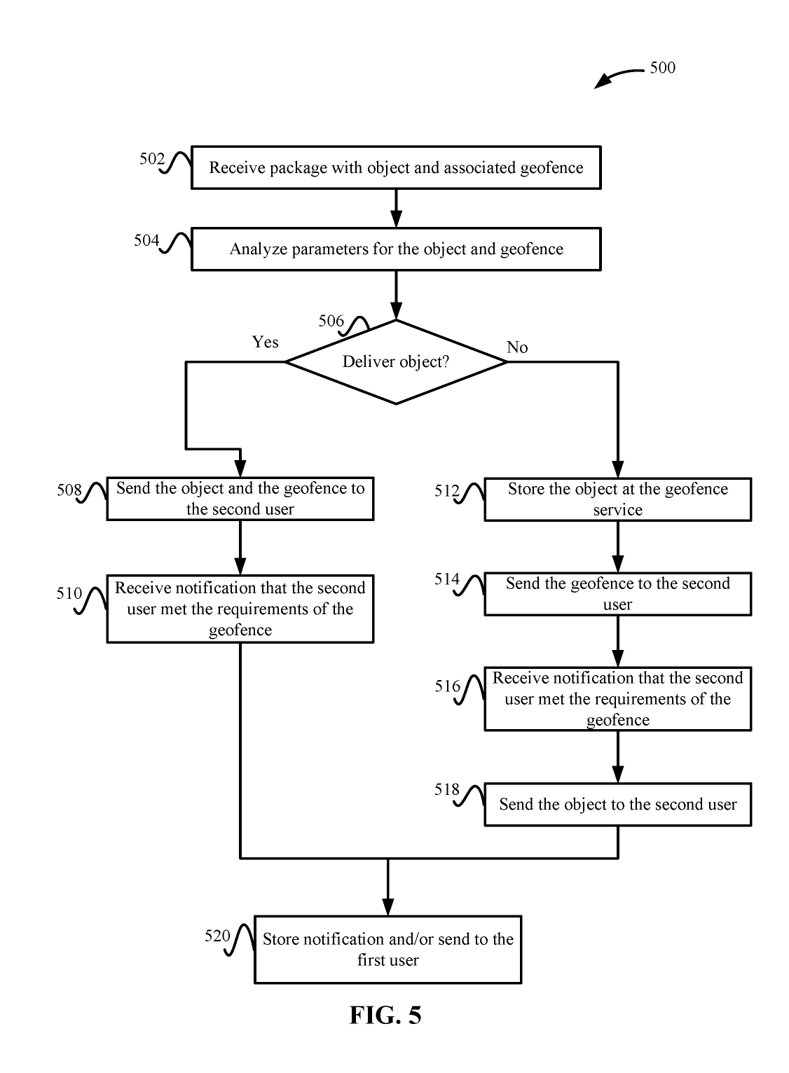

At 410, application 106-1 sends geofence 110 and/or the object to the second user. As described above, geofence service 104 may first receive and process the package. FIG. 5 depicts a simplified flowchart 500 of a method for processing the object and geofence 110 at geofence service 104 according to some embodiments. At 502, geofence service 104 receives the package with the object and associated geofence 110. At 504, geofence service 104 analyzes parameters for the object and geofence 110. For example, the parameters may specify delivery options for the object. In some embodiments, geofence service 104 provides two different options for delivery of the object. For example, geofence service 104 may forward the object and geofence 110 initially to the second user. Or, geofence service 104 may first forward geofence 110 to the second user, but not send the object until the second user is authenticated and/or meets the requirements of geofence 110.

At 506, geofence service 104 determines whether to deliver the object before the requirements of geofence 110 are met. If so, at 508, geofence service 104 sends the object and geofence 110 to the second user. Then, at some point, the second user may meet the requirements of geofence 110, such as by going within the boundary of geofence 110 using second computing device 102-2. Once the requirements are met, at 510, geofence service 104 receives a notification that the second user has met the requirements of geofence 110. At 520, geofence service 104 may then perform certain actions, such as storing an indication that the requirements of geofence 110 were met and/or sending a notification to the first user that the second user has met the requirements of geofence 110.

If the object is not to be delivered until the requirements of geofence 110 are met, at 512, geofence service 104 stores the object in storage 206. Then, at 514, geofence service 104 sends geofence 110 to the second user.

At some point, when the second user meets the requirements of geofence 110, at 516, geofence service 104 receives a notification that the second user has met the requirements of geofence 110. Then, assuming the second user has been authenticated, at 518, geofence service 104 sends the object to the second user at second computing device 102-2. Similar to above, at 520, geofence service 104 may perform certain actions.

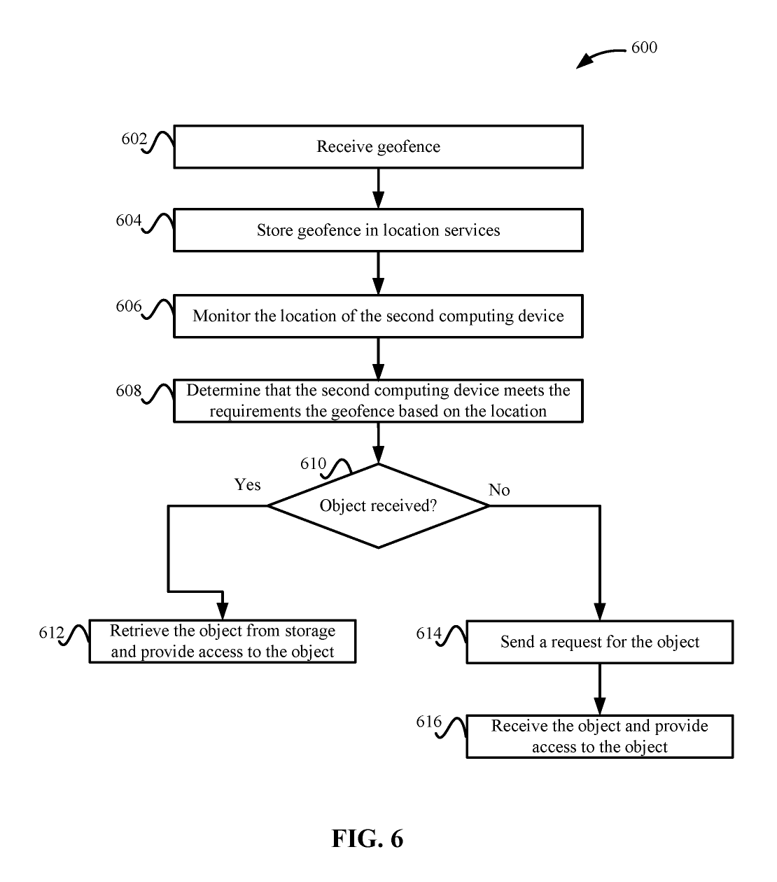

The following describes the processing at second computing device 102-2 for the two delivery options. FIG. 6 depicts a simplified flowchart 600 of a method for using geofence 110 at second computing device 102-2 according to some embodiments. Second computing device 102-2 may receive multiple communications using application 106-2, some of which include geofences 110. Application 106-2 may deliver objects that do not have any associated geofence immediately upon receipt. However, when an object has an associated geofence 110, second computing device 102-2 may perform the following method. At 602, second computing device 102-2 receives geofence 110. As mentioned above, the object may or may not be received. At 604, second computing device 102-2 stores geofence 110 in location services 108-2 of second computing device 102-2.

At 606, location services 108-2 monitors the location of second computing device 102-2. The location may be monitored continuously, periodically, or when movement is detected. At 608, location services 108-2 determines that second computing device 102-2 meets the requirements of geofence 110 based on the location. For example, location services 108 may compare the location to the boundary of geofence 110 and determine that the second user has moved within the boundary. Then, location services 108-2 notifies application 106-2 when the requirements of geofence 110 are met.

Once receiving the notification, at 610, application 106-2 determines whether or not the object was received. If the object has been received, then at 612, application 106-2 retrieves the object from storage 304. Then, the second user can access the object, such as application 106-2 displays the object.

If the object has not been received, at 614, application 106-2 sends a request for the object to geofence service 104. For example, a reference that was received with geofence 110 is used to send a request for the object. At 616, application 106-2 receives the object from geofence service 104 and provides access to the object to the second user.

In another example, the first user uploads a package of the object and geofence 110 to geofence service 104. Geofence service 104 transmits geofence 110 to the second user at second computing device 102-2. In some embodiments, the object is not included, but a reference to the package at geofence service 104 is included. Second computing device 102-2 receives geofence 110 and the reference and stores the reference to the package locally. When second computing device 102-2 meets the requirements of geofence 110, second computing device 102-2 can use the reference to download the object from geofence service 104. Then, the second user is notified and can access the object. In other embodiments, instead of including the reference, geofence service 104 send the object.

Geo-Triggered Activity Notifications

A geo-triggered activity notification may notify the first user when the second user meets the requirements of geofence 110. For example, the first user may request a notification when the second user enters or leaves a location. The first user can create a notification request as an object and associate a geofence 110 with the notification request. The first user can then send the notification request and geofence 110 to the second user. If the second user accepts, then the first user will be notified when the second user meets the requirements of geofence 110, such as when the second user moves into or out of a specified location. For example, in a messaging scenario where two users are discussing meeting at a certain location, the first user can send a message to the second user that asks the second user to let them know when the second user leaves his/her house so that the first user can leave too. The message has an attached geofence of the second user's home location. The second user agrees and second computing device 102-2 sets geofence 110. When the second user leaves his/her house, second computing device 102-2 detects the requirements of geofence 110 are met and automatically sends the first user a notification that the second user has left his/her house. Another example is a recurring notification that is sent to a first user upon the second user entering or leaving a location. For example, a husband and wife may set a recurring message based on entering or leaving his/her place of work. Whenever the husband or wife enters or leaves work, his/her computing device automatically sends a notification to the other indicating he/she has arrived or left work.

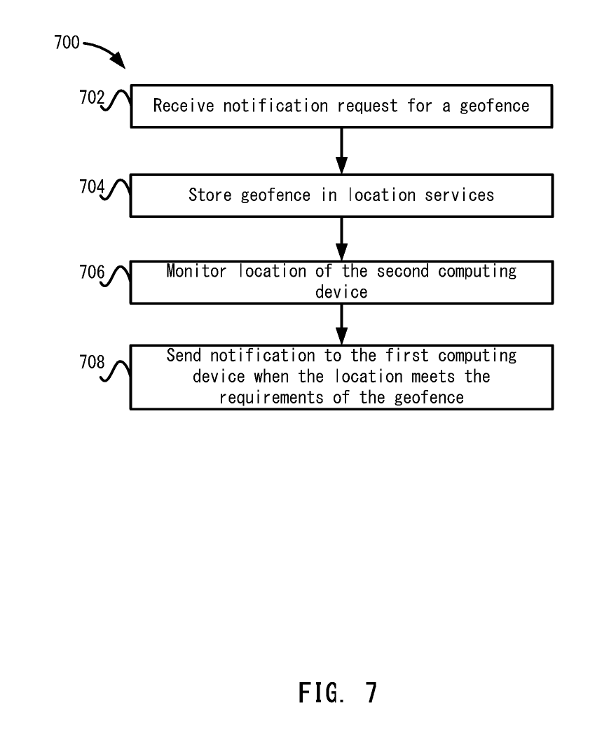

FIG. 7 depicts a simplified flowchart 700 of a method for providing geo-triggered notifications according to some embodiments. At 702, second computing device 102-2 receives a notification request for a geofence 110 from the first user. The request may be the object and includes logic to generate a notification for the first user. Then, at 704, second computing device 102-2 stores geofence 110 with location services 108-2. At 706, location services 108-2 monitors the location of second computing device 102-2. Then, at 708, second computing device 102-2 sends a notification to first computing device 102-1 when the location meets the requirements of geofence 110. For example, the detection of movement of second computing device 102-2 into or out of a location defined by geofence 110 may trigger the notification.

Geo-Locked Objects

A first user may lock an object to a particular geofence 110, such as a location, and make the object only accessible when a user meets the requirements of that geofence 110. Many scenarios could be possible with geo-locked content. For example, a three-dimensional (3D) object may be associated with a location. In some examples, a first user may create a piece of 3D art and associate it with a particular location that is either virtual or real for other users to access. However, the first user may associate a geofence 110 with the 3D art such that only second users when they are at a location can access the art. Also, a business may want to protect sensitive content by only allowing employees to access the content while at work. Alternatively, a business may not allow content to be accessed while at a location. Another example may be where a first user may want to keep their personal information, such as photographs, away from a location, such as their workplace. In this example, the first user can set a blackout zone where this content cannot be accessed by the user's computing device while in a location. Also, the object may be a service, such as stock-floor trading services when the second user is in an area that allows certain trading to be made.

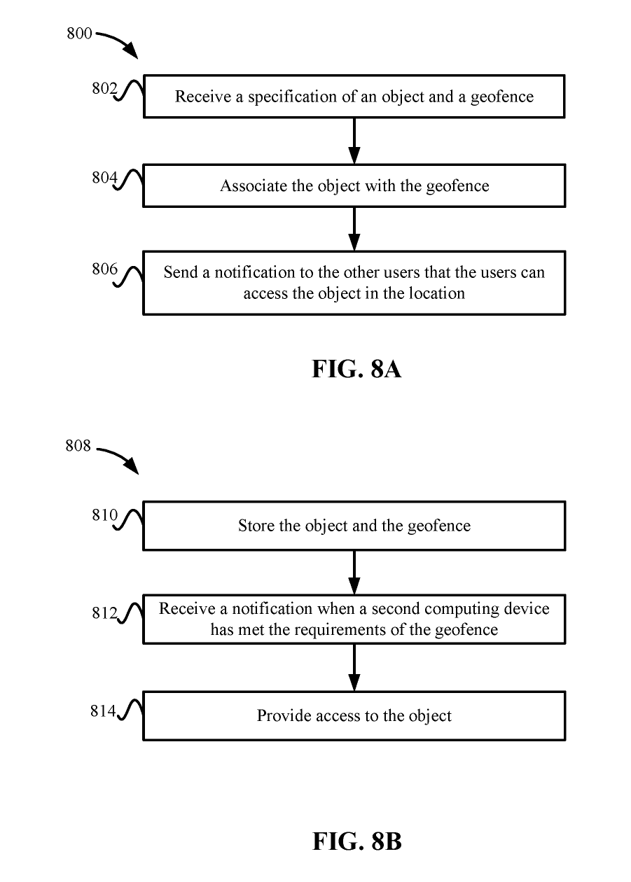

The following describes the process on first computing device 102-1 to set up a geo-locked object and then the process on second computing device 102-2 to unlock the object. FIG. 8A depicts a simplified flowchart 800 of a method for providing geo-locked content according to some embodiments. At 802, first computing device 102-1 receives a specification of an object in a geofence 110. At 804, second computing device 102-2 associates the object with geofence 110. For example, the object may be associated only with a location in which it can be accessed.

In some cases, the first user may want to notify other users that content is available; otherwise, second users may not know the content is available. This notification may encourage other users to come to that location. Accordingly, in an optional step, at 806, first computing device 102-1 sends a notification to other users that the users can access the object in the location.

FIG. 8B depicts a simplified flowchart 808 of a method for providing geo-locked content at geofence service 104 according to some embodiments. At 810, geofence service 104 stores the object and geofence 110. At 812, geofence service 104 receives a notification when a second computing device 102-2 has met the requirements of the geofence. Then, at 812, geofence service 104 provides access to the object. For example, geofence service 104 may send the object to second computing device 102-2. In some embodiments, geofence service 104 may only release the object for the second user to access when the second user meets the requirements of geofence 110.

Managing Location-Related Objects

There may be some instances where an object relying on a geofence 110 could remain un-triggered if a user never meets the requirements of geofence 110. For example, a second user with second computing device 102-2 may never move within the location for geofence 110. Different actions may be taken when objects remain untriggered. For example, applications 106 may send reminders to a user that the second user can unlock an object subject to geofence 110. The first user can also set an expiration time after which a second user cannot access the object, or the first user can choose to disable access to the object at any time.

In some embodiments, a user may access the object associated with geofence 110 when the requirements of geofence 110 have not been met. One way this can be provided is the parameters of the package (or application) may specify if a second user can disable the geofence 110 for objects. Also, the first user may set preferences as to whether the requirements of geofence 110 can be disabled by a second user or not. For example, application 106-2 may provide an override to allow the second user to access the object without meeting the requirements of geofence 110. Also, a voice-enabled assistant on second computing device 102-2 may allow access to the object. For example, a user may ask an assistant to provide all objects that have been geofenced for a location.

### Conclusion

Some embodiments allow users to remotely set a geofence on other users' computing devices. This allows objects to be accessed only when the requirements of geofence 110 are met on another user's computing device. This enhances the functionality of computing devices 102 by configuring the location services 108 to test the requirements of geofence 110. Further, the association of geofence 110 with an object provides enhanced functionality for that object. For example, the geofence requirements increases the number of services that can be provided using the object.

Example Computer System

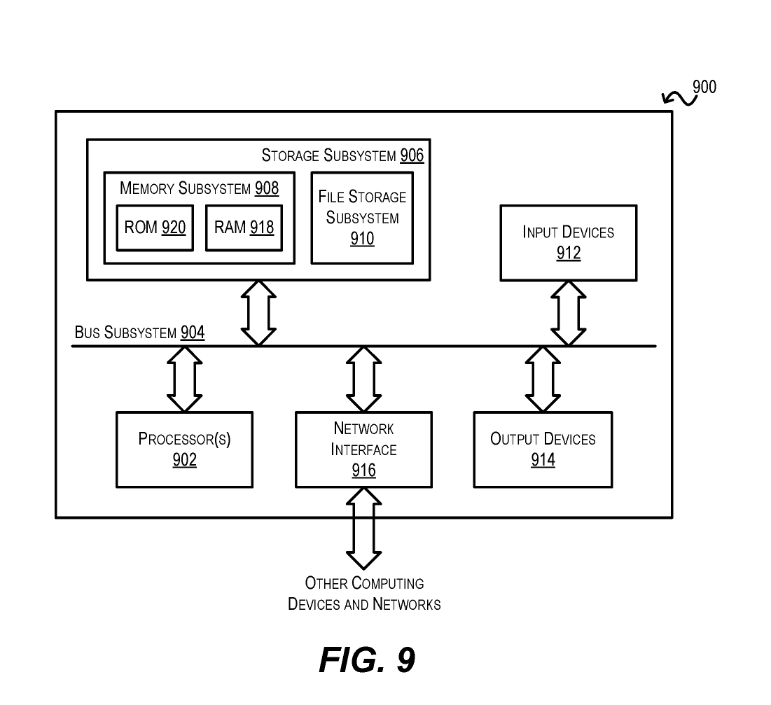

FIG. 9 depicts a simplified block diagram of an example computer system 900 according to certain embodiments. Computer system 900 can be used to implement any of the computing devices, systems, or servers described in the foregoing disclosure. As shown in FIG. 9, computer system 900 includes one or more processors 902 that communicate with a number of peripheral devices via a bus subsystem 904. These peripheral devices include a storage subsystem 906 (comprising a memory subsystem 908 and a file storage subsystem 910), user interface input devices 912, user interface output devices 914, and a network interface subsystem 916.

Bus subsystem 904 can provide a mechanism for letting the various components and subsystems of computer system 900 communicate with each other as intended. Although bus subsystem 904 is shown schematically as a single bus, alternative embodiments of the bus subsystem can utilize multiple busses.

Network interface subsystem 916 can serve as an interface for communicating data between computer system 900 and other computer systems or networks. Embodiments of network interface subsystem 916 can include, e.g., an Ethernet card, a Wi-Fi and/or cellular adapter, a modem (telephone, satellite, cable, ISDN, etc.), digital subscriber line (DSL) units, and/or the like.

User interface input devices 912 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 900.

User interface output devices 914 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 900.

Storage subsystem 906 includes a memory subsystem 908 and a file/disk storage subsystem 910. Subsystems 908 and 910 represent non-transitory computer-readable storage media that can store program code and/or data that provide the functionality of embodiments of the present disclosure.

Memory subsystem 908 includes a number of memories including a main random access memory (RAM) 918 for storage of instructions and data during program execution and a read-only memory (ROM) 920 in which fixed instructions are stored. File storage subsystem 910 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 900 is illustrative and many other configurations having more or fewer components than system 900 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A first computer system comprising:
a processor; and
a computer readable storage medium having stored thereon program code that, when executed by the processor, causes the processor to:
receive, at an application running on a platform of the first computer system, a communication for an object from a second computer system;
determine, by the application, that a geofence is associated with the object, wherein the geofence is set by the second computer system and the application restricts access to the object until a requirement associated with the geofence is met;
configure, by the application, a location service of the platform to monitor a location of the first computer system using the information for the geofence;
receive, by the application, a notification from the location service when the location of the first computer system meets a requirement of the geofence; and
perform, by the application, an action for the object when the first computer system meets the requirement of the geofence.

2. The first computer system of claim 1, wherein configuring the location service comprises:
provide a boundary for the geofence to the location service that the location service uses to detect when the location of the first computer system meets the requirement of the geofence.

3. The first computer system of claim 1, wherein:
the location service runs in a background on the platform of the first computer system to check the location of the first computer system, and
the application receives the notification from the location service without querying for the notification.

4. The first computer system of claim 3, wherein the notification is received from the location service via an interface for the platform at the application.

5. The first computer system of claim 3, wherein the application includes logic to configure the location service to monitor the location and detect when the location of the first computer system meets the requirement of the geofence.

6. The first computer system of claim 3, wherein the platform launches the application when the application is not currently running on the first computer system when the location of the first computer system meets the requirement of the geofence.

7. The first computer system of claim 1, wherein performing the action comprises:
provide access to the object on the first computer system.

8. The first computer system of claim 1, wherein performing the action comprises:
display content of the object on the first computer system.

9. The first computer system of claim 1, wherein the object is received by the first computer system after the location meets the requirement of the geofence.

10. The first computer system of claim 1, wherein performing the action comprises:
send a message to a service that is storing the object;
receive the object from the service; and
provide access to the object on the first computer system.

11. The first computer system of claim 1, wherein the object is received by the first computer system before the location of the first computer system meets the requirement of the geofence.

12. The first computer system of claim 1, wherein performing the action comprises:
send a message to the second computer system based on the location of the first computer system meeting the requirement of the geofence.

13. The first computer system of claim 12, wherein the message is sent when the first computer system moves within the geofence or moves outside of the geofence.

14. The first computer system of claim 1, wherein the program code further causes the processor to:
receive a command to override the geofence; and
upon receiving the command to override, perform the action with the object when the location of the first computer system does not meet the requirement of the geofence.

15. The first computer system of claim 1, wherein:
the object is associated with a location within the geofence,
the location of the first computer system only meets the requirement of the geofence from within the geofence, and
the object is only accessible from within the geofence.

16. The first computer system of claim 1, wherein:
the object is associated with a location outside of the geofence,
the location of the first computer system only meets the requirement of the geofence outside of the geofence, and
the object is only accessible outside of the geofence

17. The first computer system of claim 1, wherein:
receive, at the application, another communication for another object from the second computer system;
determine, by the application, that a geofence is not associated with the another object; and
immediately, by the application, provide access to the another object on the first computer system.

18. A method comprising:
receiving, at an application running on a platform of a first computer system, a communication for an object from a second computer system;
determining, by the application, that a geofence is associated with the object, wherein the geofence is set by the second computer system and the application restricts access to the object until a requirement associated with the geofence is met;
configuring, by the application, a location service of the platform to monitor a location of the first computer system using the information for the geofence;
receiving, by the application, a notification from the location service when the location of the first computer system meets a requirement of the geofence; and
performing, by the application, an action for the object when the first computer system meets the requirement of the geofence.

19. The method of claim 18, wherein:
the location service runs in a background on the platform of the first computer system to check the location of the first computer system, and
the application receives the notification from the location service without querying for the notification.

20. A computer readable storage medium having stored thereon program code executable by a computer system, the program code causing the computer system to:
receive, at an application running on a platform of the first computer system, a communication for an object from a second computer system;
determine, by the application, that a geofence is associated with the object, wherein the geofence is set by the second computer system and the application restricts access to the object until a requirement associated with the geofence is met;
configure, by the application, a location service of the platform to monitor a location of the first computer system using the information for the geofence;
receive, by the application, a notification from the location service when the location of the first computer system meets a requirement of the geofence; and
perform, by the application, an action for the object when the first computer system meets the requirement of the geofence.
